(19) United States
(12) Patent Application Publication
(10) Pub. No.: US 2017/0003855 A1
(43) Pub. Date: Jan. 5, 2017

(54) APPLICATION MANAGEMENT METHOD AND TERMINAL

(71) Applicant: GIONEE COMMUNICATION EQUIPMENT CO., LTD. SHENZHEN, Shenzhen, (CN)

(72) Inventor: Lirong LIU, Shenzhen (CN)

(73) Assignee: GIONEE COMMUNICATION EQUIPMENT CO., LTD. SHENZHEN, Shenzhen (CN)

(21) Appl. No.: 15/100,558

(22) PCT Filed: Aug. 6, 2014
(86) PCT No.: PCT/CN2014/083805

§ 371 Date: May 31, 2016

(30) Foreign Application Priority Data
Mar. 18, 2014 (CN) 201410100699.9

(51) Int. Cl. G06F 3/0481; G06F 3/0486; G06F 3/0485; G06F 3/0482

(52) U.S. Cl. CPC G06F 3/04817; G06F 3/0482; G06F 3/0486; G06F 3/0485

(57) ABSTRACT

Embodiments of the present invention disclose a method for managing applications. The method includes: opening a preset shortcut interface, wherein the shortcut interface comprises a shortcut switch region and an application sidebar region, the shortcut switch region is used to display a plurality of shortcut switch icons each corresponding to one application, and the application sidebar region is used to display application icons each corresponding to one currently run application; and exerting a corresponding operation on the applications each corresponding to one application icon in the shortcut interface and/or the applications each corresponding to one shortcut switch icon in the shortcut interface according to an operation control command input by the user performing an operation on the shortcut interface. Embodiments of the present invention further disclose a terminal.

### FIELD OF THE TECHNICAL

The present disclosure relates to electronic technology field, and particularly to a method for managing applications and a terminal.

### BACKGROUND

With the development of technology, terminal applications are emerging in an endless stream, which brings great convenience for people's daily life. However, with the development of applications, averagely, there are 40-60 applications installed in a mobile phone, and 4-6 desktops in a mobile phone. When different applications are used, the user may need to perform switch operation to switch among different applications. When a number of applications are opened simultaneously, greater memory may be taken up. After running for a long time, the running speed of the mobile phone will be reduced. At this point, it needs to exit opened applications quickly or clear currently run applications by one click.

In the existing technology, application icons are arranged on an interface vertically. It is not easy for a user to touch the application icons arranged on the upper portion by a finger, or all the applications cannot be cleared by one click, and it needs to slide the application icons one by one, which is not beneficial for quick operation. Furthermore, application shortcut switches are displayed in a notification bar, thus the complexity of the notification bar increases and it is not beneficial for the user to look up notifications.

### SUMMARY

The embodiments of the present invention provides a method for managing applications and a terminal. By means of the embodiments of the present invention, a shortcut switch region and an application sidebar region can be simultaneously displayed in the shortcut interface, thereby increasing maneuverability of interface icons and increasing user's usage experience.

The embodiments of the present invention provides a method for managing applications. The method includes the following.

Opening a preset shortcut interface. The shortcut interface comprises a shortcut switch region and an application sidebar region. The shortcut switch region is used to display a plurality of shortcut switch icons each corresponding to one application, and the application sidebar region is used to display application icons each corresponding to one currently run application.

Exerting a corresponding operation on the applications each corresponding to one application icon in the shortcut interface and/or the applications each corresponding to one shortcut switch icon in the shortcut interface according to an operation control command input by the user performing an operation on the shortcut interface.

Accordingly, the embodiments of the present invention provides a terminal. The terminal includes the following.

An interface opening unit is configured to open a preset shortcut interface. The shortcut interface comprises a shortcut switch region and an application sidebar region. Wherein, the shortcut switch region is used to display a plurality of shortcut switch icons each corresponding to one application, and the application sidebar region is used to display application icons each corresponding to one currently run application.

An operation control unit is configured to exert a corresponding operation on the applications each corresponding to one application icon in the shortcut interface and/or the applications each corresponding to one shortcut switch icon in the shortcut interface according to an operation control command input by the user performing an operation on the shortcut interface.

By means of the embodiments of the present invention, a preset shortcut interface is opened. The shortcut interface includes a shortcut switch region and an application sidebar region. Wherein, the shortcut switch region is used to display a number of shortcut switch icons each corresponding to one application, and the application sidebar region is used to display application icons each corresponding to one currently run application. According to the operation control command input by a user performing an operation on the shortcut interface, a corresponding operation is exerted on the applications each corresponding to one application icon in the shortcut interface and/or on the applications each corresponding to one shortcut switch icon in the shortcut interface. By means of the embodiments of the present invention, the shortcut switch region and the application sidebar region can be simultaneously displayed in the shortcut interface, thus the existing technical problem caused by the complexity of a notification bar and inconvenience of looking up notifications due to displaying application shortcut switches in the notification bar can be solved, thereby increasing maneuverability of interface icons and improving user's usage experience.

### BRIEF DESCRIPTION OF THE DRAWINGS

To better illustrate the technical solution of embodiments of the present invention, the following descriptions will briefly illustrate the accompanying drawings described in the embodiments. Obviously, the following described accompanying drawings are some embodiments of the present invention. Those skilled in the art can obtain other accompanying drawings according to the described accompanying drawings without creative work.

FIG. 1 is a flow chart of a method for managing applications in accordance with an exemplary embodiment of the present invention.

FIG. 2 is a schematic view showing a shortcut interface in accordance with an exemplary embodiment of the present invention.

FIG. 3 is a schematic view showing performing an operation on application icons in accordance with a first embodiment of the present invention.

FIG. 4 is a schematic view showing performing an operation on application icons in accordance with a second embodiment of the present invention.

FIG. 5 is a schematic view showing performing an operation on application icons in accordance with a third embodiment of the present invention.

FIG. 6 is a schematic view showing performing an operation on application icons in accordance with a fourth embodiment of the present invention.

FIG. 7 is a schematic view showing performing an operation on application icons in accordance with a fifth embodiment of the present invention.

FIG. 8 is a flow chart of a method for managing applications in accordance with another exemplary embodiment of the present invention.

FIG. 9 is a schematic view of a structure of a terminal in accordance with an exemplary embodiment of the present invention.

FIG. 10 is a schematic view of a structure of an operation control unit of a terminal in accordance with an exemplary embodiment of the present invention.

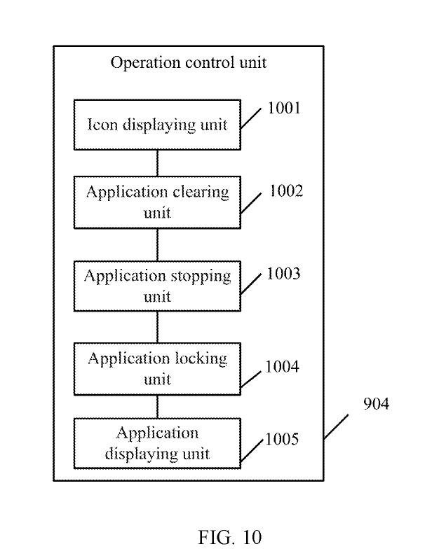

FIG. 11 is a schematic view of a structure of a terminal in accordance with another exemplary embodiment of the present invention.

### DETAILED DESCRIPTION OF ILLUSTRATED EMBODIMENTS

The technical solution of embodiments of the present invention will be described clearly and completely in combination with the accompanying drawings of the embodiments of the present invention. Obviously, the described embodiments are a part of embodiments of the present invention, and not all of the embodiments. According to the embodiments of the present invention, other embodiments obtained by those skilled in the art without creative work all fall within the protection scope of the present invention.

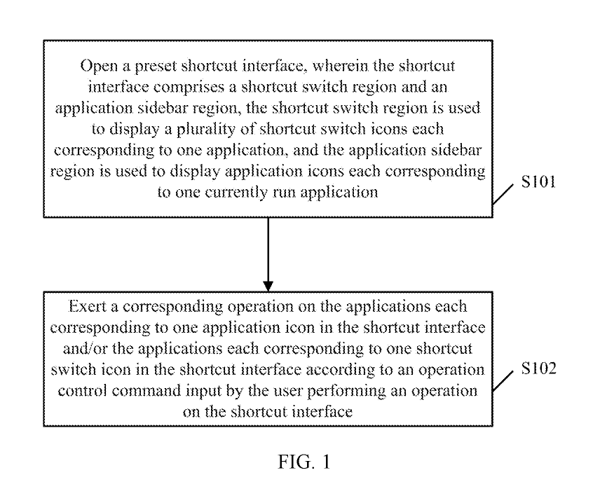

Referring to FIG. 1, FIG. 1 is a flow chart of a method for managing applications in accordance with an exemplary embodiment of the present invention. As shown in FIG. 1, the method in accordance with an exemplary embodiment of the present invention at least includes the following.

In step S101, opening a preset shortcut interface. The shortcut interface includes a shortcut switch region and an application sidebar region. Wherein, the shortcut switch region is used to display a number of shortcut switch icons each corresponding to one application, and the application sidebar region is used to display application icons each corresponding to one currently run application.

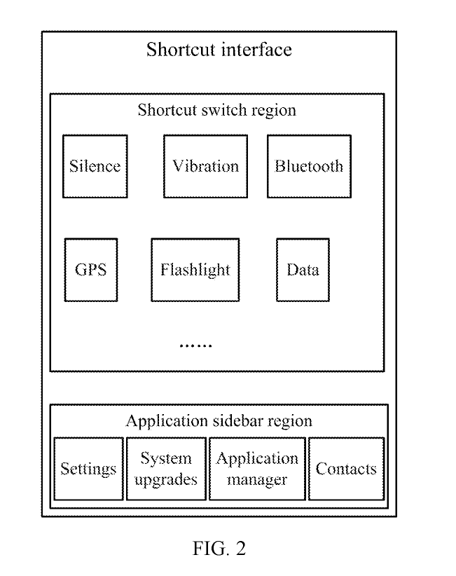

Specifically, as shown in FIG. 2, FIG. 2 shows a shortcut interface displayed on a screen in accordance with an exemplary embodiment of the present invention. In the shortcut switch region, the shortcut switch icons of Bluetooth, silence, vibration, GPS, and others are included. In the application sidebar region, the application icons of settings, application manager, contacts, system upgrades, and others are included. It needs to point out that only a portion of shortcut switch icons are displayed in the shortcut switch region shown in FIG. 2, and the application sidebar region can be arranged on the bottom of the screen. The position of the application sidebar region is not limited to the position shown in FIG. 2, and the application sidebar region can be arranged on the other sidebar of the screen. Also, according to the currently run applications, all the application icons each corresponding to one currently run application are displayed in the application sidebar region.

In step S102, exerting a corresponding operation on the applications each corresponding to one application icon in the shortcut interface or on the applications each corresponding to one shortcut switch icon in the shortcut interface according to an operation control command input by a user performing an operation on the shortcut interface.

Specifically, an application corresponding to one shortcut switch icon can be started or closed by clicking the shortcut switch icon in the shortcut switch region. For example, in the shortcut switch region shown in FIG. 2, if the application of Bluetooth is opened, when the shortcut switch icon of the application of Bluetooth is clicked, the application of Bluetooth is closed. If the application of Bluetooth is closed, when the shortcut switch icon of the application of Bluetooth is clicked, the application of Bluetooth stops running. Also, application switch can be executed by clicking one application icon in the application sidebar region, and when one application icon in the application sidebar region is clicked, the application corresponding to the clicked application icon is displayed.

Exerting a corresponding operation on the applications each corresponding to one application icon in the shortcut interface can further include the following.

Optionally, the operation control command is input by dragging the application sidebar region along a direction until a distance between a side of the application sidebar region opposite to the drag direction and any border of the screen reaches a preset threshold. After receiving the operation control command, an application icon which is used to indicate stop of applications is displayed in the side of the application sidebar region opposite to the drag direction.

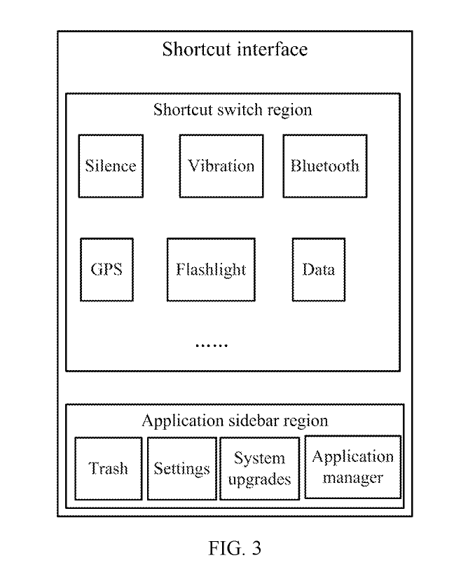

For example, as shown in FIG. 3, when the application sidebar region is dragged to right until a distance between the left side of the application sidebar region and the left border of the screen reaches the preset threshold, an application icon of trash is displayed in the left side of the application sidebar region.

Furthermore, under the condition of that the user is prompted by the application icon which is used to indicate stop of applications to select whether or not to stop running applications, after the operation control command input by releasing the drag operation on the application sidebar region is received, all applications each corresponding to one unlocked application icon in the application sidebar region stop running.

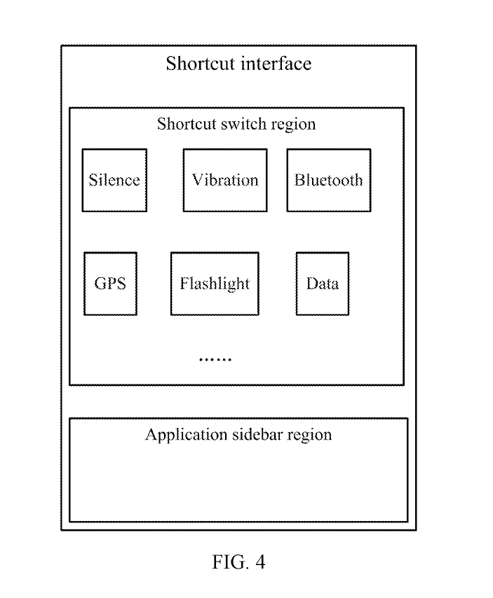

For example, as shown in FIG. 4, when the application icon of trash is fully displayed in the application sidebar region, it indicates that an operation of stopping running applications can be executed. At this point, after an operation control command input by releasing the lateral drag operation from left to right is received, in the application sidebar region, the application icons of settings, application manager, contacts, system upgrades, and others are all cleared. Accordingly, all of the applications corresponding to the application icons of settings, application manager, contacts, system upgrades, and others stop running.

Optionally, the operation control command is input by dragging one application icon in the application sidebar region away from the application sidebar region. After receiving the operation control command, the application corresponding to the application icon dragged away from the application sidebar region stops running.

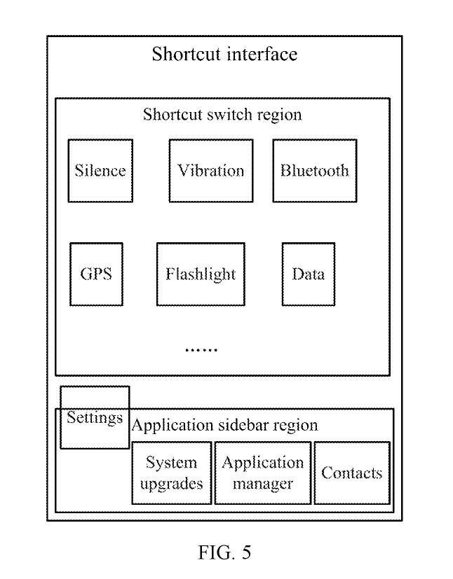

For example, as shown in FIG. 5, when the application icon of settings is moved upward to be away from the application sidebar region, the application icon of settings is cleared. Accordingly, the application corresponding to the application icon of settings stops running.

Optionally, the operation control command is input by dragging one application icon in the application sidebar region away from the application sidebar region. After receiving the operation control command, the application corresponding to the application icon dragged away from the application sidebar region is locked and runs.

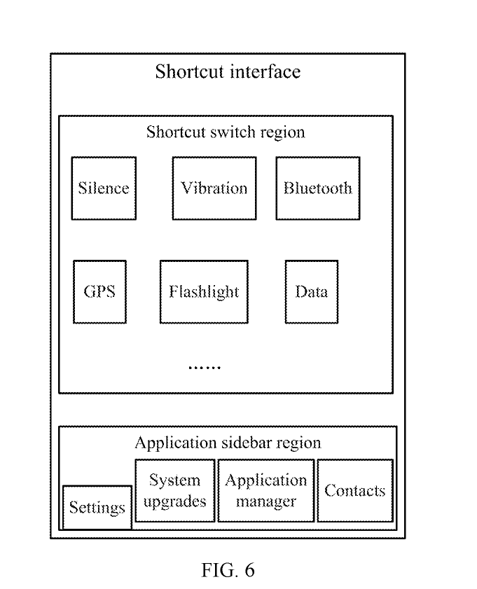

For example, as shown in FIG. 6, the application icon of settings is moved downward to be away from the application sidebar region, the application icon of settings is locked. Accordingly, the application corresponding to the application icon of settings is locked. Wherein, during the process of clearing all the application icons each corresponding to one currently run application upon receiving the operation control command input by releasing the drag operation on the application sidebar region, the locked applications cannot be cleared.

Optionally, the operation control command is input by dragging the application sidebar region within a preset range. After receiving the operation control command, all the application icons in the application sidebar region are scrolled through along the direction of dragging the application sidebar region within the preset range.

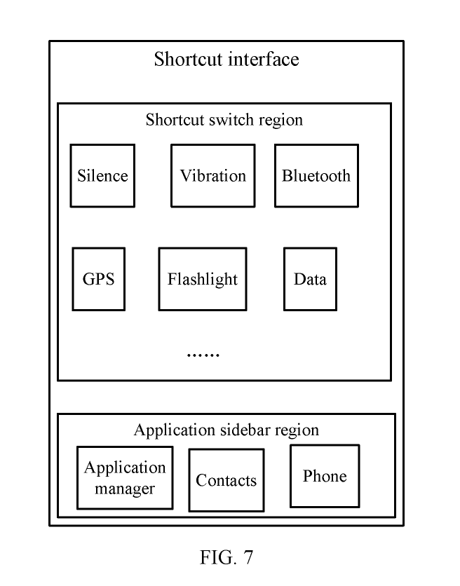

For example, as shown in FIG. 7, when the application sidebar region is moved to left within the preset range, an application icon of phone which has not been previously displayed is displayed. If there are a number of currently run applications, the application sidebar region can be further dragged to left. If the application sidebar region is moved to right, the application sidebar region is returned to its previous state.

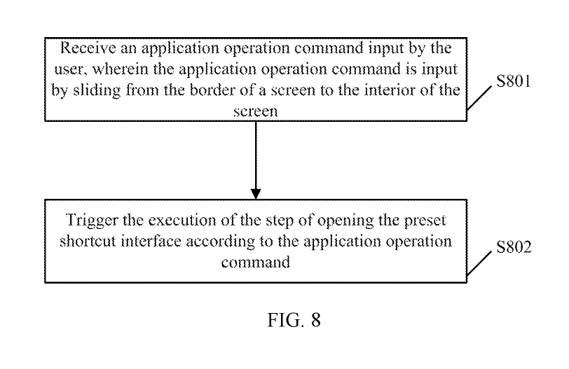

Referring to FIG. 8, FIG. 8 is a flow chart of a method for managing application icons in accordance with another exemplary embodiment of the present invention. As shown in FIG. 8, the method in accordance with another embodiment of the present invention at least includes the following.

In step S801, receiving an application operation command input by the user. The application operation command is input by sliding from the border of the screen to the interior of the screen.

It needs to point out that in the embodiment of the present invention no matter what interface is displayed, the application operation command input by sliding from the border of the screen to the interior of the screen can be received.

In step S802, triggering the execution of the step of opening the preset shortcut interface according to the application operation command.

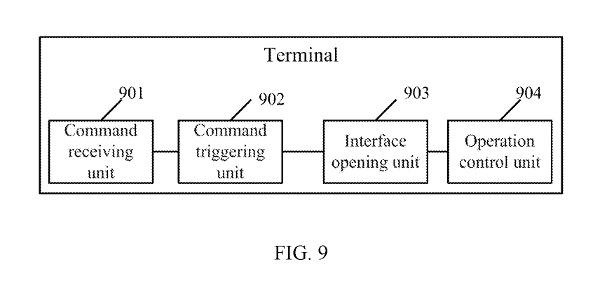

Referring to FIG. 9, FIG. 9 shows a terminal of an exemplary embodiment of the present invention. The terminal includes a command receiving unit 901, a command triggering unit 902, an interface opening unit 903, and an operation control unit 904.

The command receiving unit 901 is configured to receive an application operation command input by the user. The application operation command is input by sliding from the border of the screen to the interior of the screen.

It needs to point out that in the embodiment of the present invention no matter what interface is displayed, the application operation command input by sliding from the border of the screen to the interior of the screen can be received.

The command triggering unit 902 is configured to trigger the execution of the step of opening the preset shortcut interface according to the application operation command.

The interface opening unit 903 is configured to obtain and open the preset shortcut interface. The shortcut interface includes a shortcut switch region and an application sidebar region. Wherein, the shortcut switch region is used to display a number of shortcut switch icons each corresponding to one application, and the application sidebar region is used to display application icons each corresponding to one currently run application.

Specifically, as shown in FIG. 2, FIG. 2 shows a shortcut interface displayed on a screen in accordance with an exemplary embodiment of the present invention. In the shortcut switch region, the shortcut switch icons of Bluetooth, silence, vibration, GPS, and others are included. In the application sidebar region, the application icons of settings, application manager, contacts, and system upgrades, and others are included. It needs to point out that only a portion of shortcut switch icons are displayed in the shortcut switch region shown in FIG. 2, and the application sidebar region can be arranged on the bottom of the screen. The position of the application sidebar region is not limited to the position shown in FIG. 2, and the application sidebar region can be arranged on the other sidebar of the screen. Also, according to the currently run applications, all the application icons each corresponding to one currently run application are displayed in the application sidebar region.

The operation control unit 904 is configured to exert a corresponding operation on the applications each corresponding to one application icon in the shortcut interface or on the applications each corresponding to one shortcut switch icon in the shortcut interface according to an operation control command input by a user performing an operation on the shortcut interface.

Specifically, an application corresponding to one shortcut switch icon can be started or closed by clicking the shortcut switch icon in the shortcut switch region. For example, in the shortcut switch region shown in FIG. 2, if the application of Bluetooth is opened, when the shortcut switch icon of the application of Bluetooth is clicked, the application of Bluetooth is closed. If the application of Bluetooth is closed, when the shortcut switch icon of the application of Bluetooth is clicked, the application of Bluetooth stops running. Also, application switch can be executed by clicking one application icon in the application sidebar region, and when one application icon in the application sidebar region is clicked, the application corresponding to the clicked application icon is displayed.

Optionally, the operation control unit 904 further includes an icon displaying unit 1001, an application clearing unit 1002, an application stopping unit 1003, an application locking unit 1004, and an application displaying unit 1005.

The icon displaying unit 1001 is configured to display an application icon which is used to indicate stop of applications in a side of the application sidebar region opposite to the drag direction.

Specifically, the operation control command is input by dragging the application sidebar region along a direction until a distance between a side of the application sidebar region opposite to the drag direction and any border of the screen reaches a preset threshold. After receiving the operation control command, an application icon which is used to indicate stop of applications is displayed in a side of the application sidebar region opposite to the drag direction.

For example, as shown in FIG. 3, when the application sidebar region is dragged to right until a distance between the left side of the application sidebar region and the left border of the screen reaches the preset threshold, an application icon of trash is displayed in the left side of the application sidebar region.

The application clearing unit 1002 is configured to stop running all the applications each corresponding to one unlocked application icon in the application sidebar region.

Specifically, under the condition of that the user is prompted by the application icon which is used to indicate stop of applications to select whether or not to stop running applications, after the operation control command input by releasing the drag operation on the application sidebar region is received, all of the applications each corresponding to one unlocked application icon in the application sidebar region stop running.

For example, as shown in FIG. 4, when the application icon of trash is fully displayed in the application sidebar region, it indicates that an operation of stopping running applications can be executed. At this point, after an operation control command input by releasing the drag operation on the application sidebar region is received, in the application sidebar region, the application icons of settings, application manager, contacts, system upgrades, and others are all cleared. Accordingly, all of the applications corresponding to the application icons of settings, application manager, contacts, system upgrades, and others stop running.

The application stopping unit 1003 is configured to stop running the application corresponding to the application icon dragged away from the application sidebar region.

Optionally, the operation control command is input by dragging one application icon in the application sidebar region away from the application sidebar region. After receiving the operation control command, the application corresponding to the application icon dragged away from the application sidebar region stops running.

For example, as shown in FIG. 5, when the application icon of settings is moved upward to be away from the application sidebar region, the application icon of settings is cleared. Accordingly, the application corresponding to the application icon of settings stops running.

The application locking unit 1004 is configured to lock and run the application corresponding to the application icon dragged away from the application sidebar region.

Specifically, the operation control command is input by dragging one application icon in the application sidebar region away from the application sidebar region. After receiving the operation control command, the application corresponding to the application icon dragged away from the application sidebar region is locked and runs.

For example, as shown in FIG. 6, the application icon of settings is moved downward to be away from the application sidebar region, the application icon of settings is locked. Accordingly, the application corresponding to the application icon of settings is locked. Wherein, during the process of clearing all the application icons each corresponding to one currently run application upon receiving the operation control command input by releasing the drag operation on the application sidebar region, the locked applications cannot be cleared.

The application displaying unit 1005 is configured to scroll through all the application icons in the application sidebar region along the direction of dragging the application sidebar region within a preset range.

Specifically, the operation control command is input by dragging the application sidebar region within the preset range. After receiving the operation control command, all the application icons in the application sidebar region are scrolled through along the direction of dragging the application sidebar region within the preset range.

For example, as shown in FIG. 7, when the application sidebar region is moved to left within the preset range, an application icon of phone which has not been previously displayed is displayed. If there are a number of currently run applications, the application sidebar region can be further dragged to left laterally. If the application sidebar region is moved to right laterally, the application sidebar region is returned to its previous state.

The embodiments of the present invention provides a method for managing applications and a terminal. A preset shortcut interface is opened. The shortcut interface includes a shortcut switch region and an application sidebar region. Wherein, the shortcut switch region is used to display a number of shortcut switch icons each corresponding to one application, and the application sidebar region is used to display application icons each corresponding to one currently run application. According to the operation control command input by the user performing an operation on the shortcut interface, a corresponding operation is exerted on the applications each corresponding to one application icon in the shortcut interface and/or on the applications each corresponding to one shortcut switch icon in the shortcut interface. By means of the embodiments of the present invention, the shortcut switch region and the application sidebar region can be simultaneously displayed in the shortcut interface, thereby increasing maneuverability of interface icons and improving user's usage experience.

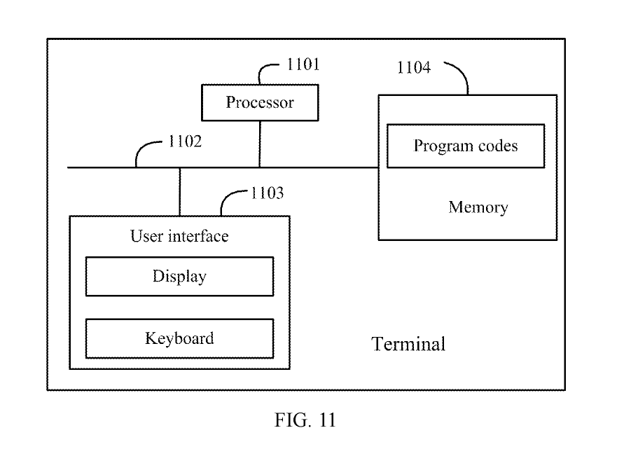

FIG. 11 is a schematic view of a structure of a terminal in accordance with another exemplary embodiment of the present invention. As shown in FIG. 11, the terminal includes at least one processor 1101 (e.g., CPU), at least one user interface 1103, a memory 1104, and at least one communication bus 1102. Wherein, the communication bus 1102 is configured to realize communication among these assemblies. Wherein, the user interface 1103 can include a display and a keyboard. Optionally, the user interface 1103 can further include standard wired interfaces and wireless interfaces. The memory 1104 can be a high-speed RAM, or can be a non-volatile memory, such as at least one disc memory. Optionally, the memory 1104 can be at least one storage device which is away from the processor 1101. The memory 1104 stores a plurality of program codes. The processor 1101 invokes the program codes stored in the memory 1104 to execute the following operations.

An operation is to open a preset shortcut interface. The shortcut interface includes a shortcut switch region and an application sidebar region. Wherein, the shortcut switch region is used to display a number of shortcut switch icons each corresponding to one application, and the application sidebar region is used to display application icons each corresponding to one currently run application.

An operation is to exert a corresponding operation on the applications each corresponding to one application icon in the shortcut interface or on the applications each corresponding to one shortcut switch icon in the shortcut interface according to an operation control command input by a user performing an operation on the shortcut interface.

According to actual need, the order of the steps of the methods in the embodiments of the present invention can be adjusted, some steps can be merged into one step, and some step can be deleted.

According to actual need, some units of the device in the embodiments of the present invention can be merged into one unit, some unit can be divided into several units, and some unit can be deleted.

The units in all embodiments of the present invention can be realized by a universal integrated circuit, such as a CPU (Central Processing unit, CPU) for example, or by an ASIC (Application Specific Integrated Circuit, ASIC).

One of ordinary skill in the art can understand that all or part of process can be accomplished by using a computer program to instruct related hardware. All the program can be stored in a computer-readable storage medium. When the program is executed, the process of the embodiments of the above-mentioned methods can be included. Wherein, the storage medium can be a magnetic disk, an optical disk, a ROM (Read-Only Memory, ROM), a RAM (Random Access Memory, RAM), or the like.

The embodiments described above are merely preferred ones of the present disclosure but are not limitations to the protection scope of the present disclosure, thus equivalent variations made according to the appended claims of the present invention still fall within the scope of the present invention.

What is claimed is:

1. A method for managing applications, comprising:
opening a preset shortcut interface, wherein the shortcut interface comprises a shortcut switch region and an application sidebar region, the shortcut switch region is used to display a plurality of shortcut switch icons each corresponding to one application, and the application sidebar region is used to display application icons each corresponding to one currently run application; and
exerting a corresponding operation on the applications each corresponding to one application icon in the shortcut interface and/or the applications each corresponding to one shortcut switch icon in the shortcut interface according to an operation control command input by the user performing an operation on the shortcut interface.

2. The method of claim 1, wherein before obtaining and opening the preset shortcut interface, the method further comprises:
receiving an application operation command input by the user, wherein the application operation command is input by sliding from the border of a screen to the interior of the screen; and
triggering the execution of the step of opening the preset shortcut interface according to the application operation command.

3. The method of claim 1, wherein the operation control command is input by dragging the application sidebar region until a distance between a side of the application sidebar region opposite to the drag direction and any border of a screen reaches a preset threshold, exerting a corresponding operation on the applications each corresponding to one application icon in the shortcut interface comprises displaying an application icon which is used to indicate stop of applications in the side of the application sidebar region opposite to the drag direction, and exerting a corresponding operation on the applications each corresponding to one application icon in the shortcut interface when an operation control command input by releasing the drag operation on the application sidebar region is received under the condition of that the user is prompted by the application icon which is used to indicate stop of applications to select whether or not to stop running applications, wherein exerting a corresponding operation on the applications each corresponding to one application icon in the shortcut interface comprises stopping running all applications each corresponding to one unlocked application icon in the application sidebar region.

4. The method of claim 1, wherein the operation control command is input by dragging one application icon in the application sidebar region away from the application sidebar region, exerting a corresponding operation on the applications each corresponding to one application icon in the shortcut interface comprises stopping running the application corresponding to the application icon dragged away from the application sidebar region.

5. The method of claim 1, wherein the operation control command is input by dragging one application icon in the application sidebar region away from the application sidebar region, exerting a corresponding operation on the applications each corresponding to one application icon in the shortcut interface comprises locking and running the application corresponding to the application icon dragged away from the application sidebar region.

6. The method of claim 1, wherein the operation control command is input by dragging the application sidebar region within a preset range, exerting a corresponding operation on the applications each corresponding to one application icon in the shortcut interface comprises scrolling through the application icons in the application sidebar region along the direction of dragging the application sidebar region within the preset range.

7. A terminal comprising:
an interface opening unit configured to open a preset shortcut interface, wherein the shortcut interface comprises a shortcut switch region and an application sidebar region, the shortcut switch region is used to display a plurality of shortcut switch icons each corresponding to one application, and the application sidebar region is used to display application icons each corresponding to one currently run application; and
an operation control unit configured to exert a corresponding operation on the applications each corresponding to one application icon in the shortcut interface and/or the applications each corresponding to one shortcut switch icon in the shortcut interface according to an operation control command input by the user performing an operation on the shortcut interface.

8. The terminal of claim 7, wherein the terminal further comprises a command receiving unit configured to receive an application operation command input by the user, the application operation command is input by sliding from the border of a screen to the interior of the screen, the terminal further comprises a command triggering unit configured to trigger the interface opening unit to execute the step of opening the preset shortcut interface according to the application operation command.

9. The terminal of claim 7, wherein the operation control command is input by dragging the application sidebar region until a distance between a side of the application sidebar region opposite to the drag direction and any border of a screen reaches a preset threshold, the operation control unit comprises an icon displaying unit configured to display an application icon which is used to indicate stop of applications in the side of the application sidebar region opposite to the drag direction, and an application clearing unit configured to stop running all applications each corresponding to one unlocked application icon in the application sidebar region when an operation control command input by releasing the drag operation on the application sidebar region is received under the condition of that the user is prompted by the application icon which is used to indicate stop of applications to select whether or not to stop running applications.

10. The terminal of claim 7, wherein the operation control command is input by dragging one application icon in the application sidebar region away from the application sidebar region, the operation control unit comprises an application stopping unit configured to stop running the application corresponding to the application icon dragged away from the application sidebar region.

11. The terminal of claim 7, wherein the operation control command is input by dragging one application icon in the application sidebar region away from the application sidebar region, the operation control unit comprises an application locking unit configured to lock and run the application corresponding to the application icon dragged away from the application sidebar region.

12. The terminal of claim 7, wherein the operation control command is input by dragging the application sidebar region within a preset range, the operation control unit comprises an application displaying unit configured to scroll through the application icons in the application sidebar region along the direction of dragging the application sidebar region within the preset range.

13. A terminal comprising:
a user interface;
a memory storing a plurality program codes; and
a processor configured to invoke the plurality of program codes stored in the memory to:
open a preset shortcut interface, wherein the shortcut interface comprises a shortcut switch region and an application sidebar region, the shortcut switch region is used to display a plurality of shortcut switch icons each corresponding to one application, and the application sidebar region is used to display application icons each corresponding to one currently run application; and
exert a corresponding operation on the applications each corresponding to one application icon in the shortcut interface and/or the applications each corresponding to one shortcut switch icon in the shortcut interface according to an operation control command input by the user performing an operation on the shortcut interface.
